(19) United States
(12) Patent Application Publication
(10) Pub. No.: US 2016/0058672 A1
(43) Pub. Date: Mar. 3, 2016

(54) Baby bottle designed for cleaning without a brush

(71) Applicant: Michael Darrell Bailey, Philadelphia, PA (US)

(72) Inventor: Michael Darrell Bailey, Philadelphia, PA (US)

(21) Appl. No.: 14/121,417

(22) Filed: Sep. 3, 2014

(51) Int. Cl. A61J 9/00; B65D 13/00

(52) U.S. Cl. CPC A61J 9/00; B65D 13/00

(57) ABSTRACT

The present invention is an improved baby bottle with at least one wide diameter aperture to allow persons who have large hands to clean the bottle without using a brush. The baby bottle is comprised of an upper body, a lower body, and a coupler. The upper body and the lower body are connected by the coupler. The exterior surface of upper body and the exterior surface of the lower body have threaded necks that surround the apertures of the upper and lower bodies respectively. The apertures of the baby bottle are of sufficient size to accommodate a human hand. The threaded necks of the upper body and threaded neck of the lower body allow the upper and lower bodies to be screwed into threads of the interior surface of the coupler.

### BACKGROUND OF INVENTION

1. Field of Invention

This invention pertains to improvements in baby bottles. More particularly, this invention relates to a baby bottle that is easier to clean than most prior art baby bottles. The baby bottle can be cleaned easily, whether it is assembled or unassembled.

2. Description of Prior Art

A variety of baby bottles and nursing units have been developed in the past. Typically, these bottles comprise a main narrow body, with an integral threaded neck, and a collar for securing a nipple to a threaded neck. Traditional baby bottles are often difficult to clean because of the small diameter of the main body.

Every parent has been faced with the problem of trying to thoroughly clean a narrow container, such as traditional baby bottles. Use of soapy cleaning agents is often not sufficient for thorough cleaning since liquid baby food contains fatty liquids and suspended solids, such as cereal. There is often difficulty dislodging residue in the narrow crevices of the container or bottle.

In such cases, parents have resorted to washing the narrow body of traditional baby bottles with a high pressure water rinse. A high pressure water rinse, can lead to unnecessary usage of a high volume of water and can also result in spraying of water on the person who is cleaning the bottle. Additionally, a high pressure rinse is not sufficient to remove certain types of materials from the interior surface of the baby bottle.

Additionally, parents have resorted to using a brush for lifting and removing dried up solids that deposited on the interior surface of the infant bottle. The abrasive action of the brush helps in removing impurities from the inside of the bottle that cannot be removed by simply using cleaning liquid in the bottle. However, constant use of a brush to clean a baby bottle can chip away at the sides of the baby bottle. Using a brush to clean baby bottles also results in spraying water on the surrounding area or person working with the bottle. There is also time involved in cleaning re-used brushes and/or expense in buying new brushes to clean baby bottles.

What is desired is a baby bottle with wide diameter apertures, such that the bottle is easier to clean than the traditional baby bottle and such that a brush is not needed to clean the baby bottle.

### SUMMARY OF THE INVENTION

The present invention is an improved baby bottle with at least one wide diameter aperture to allow persons who have large hands to clean the bottle without using a brush. As used herein, the term bottle is to be broadly construed and is inclusive of bottles, containers, drinking apparatus, and similar items.

This invention is particularly useful for persons who have large hands that do not fit inside of traditional baby bottles that have a narrow body. More particularly, the wide diameter apertures of the present invention allow the user to clean the bottle without having to utilize a brush. The user, simply, washes the baby bottle by rubbing the interior surface of the baby bottle with a cloth covered with cleaning solution.

The present invention is comprised of an upper body, a lower body, and a coupler. The upper body and the lower body are connected by the coupler. The exterior surface of upper body and the exterior surface of the lower body have threaded necks that surround the apertures of the upper and lower bodies respectively. The threaded necks of the upper body and threaded neck of the lower body allow the upper and lower bodies to be screwed into threads of the interior surface of the coupler.

The upper body comprises an exterior surface, an interior surface, at least two apertures, and at least two threaded necks on the exterior surfaces that surround each aperture of the upper body. The apertures of the upper body are of sufficient size to accommodate the human hand and to allow for cleaning the bottle without using a brush.

The lower body comprises an exterior surface, an interior surface, a base, at least one aperture, and a threaded neck on the exterior surface surrounding the aperture. The wide diameter of the aperture of the lower body is of sufficient size to accommodate the human hand and allows for cleaning the bottle without using a brush.

The coupler comprises an exterior surface, a threaded interior surface, and at least one aperture of sufficient size to accommodate a human hand. The coupler connects the upper body and lower body. A threaded neck of the upper body is screwed into the coupler in the assembled bottle. Also in an assembled bottle, a threaded neck of the lower body is screwed into the coupler. The diameters of the apertures of the coupler, upper body, and lower body are all of sufficient size to accommodate the human hand and this allows for cleaning the bottle without using a brush.

### BRIEF DESCRIPTION OF DRAWINGS

The foregoing and other objects will become more readily apparent by referring to the following detailed description and the appended drawings in which:

FIG. 1 is a perspective view of the baby bottle, showing in particular the preferred embodiment assembled and displayed in a vertical position.

FIG. 2 is an exploded view of the baby bottle of FIG. 1 in an unassembled state showing in particular, the upper body, lower body, and the coupler.

FIG. 3 is a top plan view of the baby bottle of FIG. 1 showing one of the apertures of the upper body and a threaded neck of the upper body.

FIG. 4 is a bottom plan view of the baby bottle of FIG. 1, showing the base of the lower body.

### DETAILED DESCRIPTION OF THE INVENTION

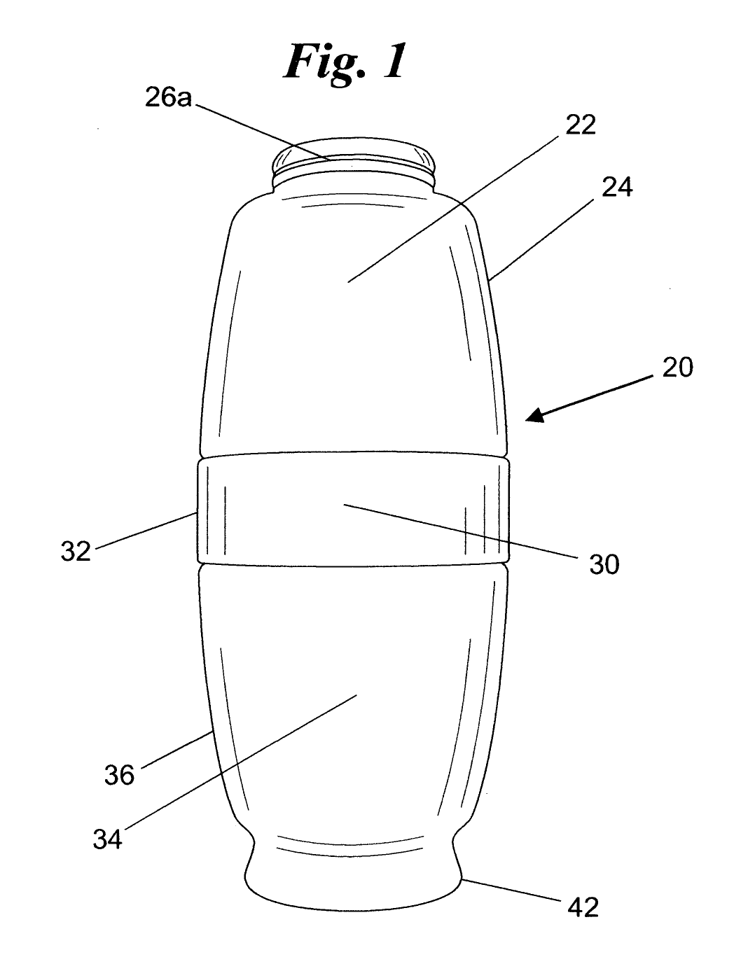

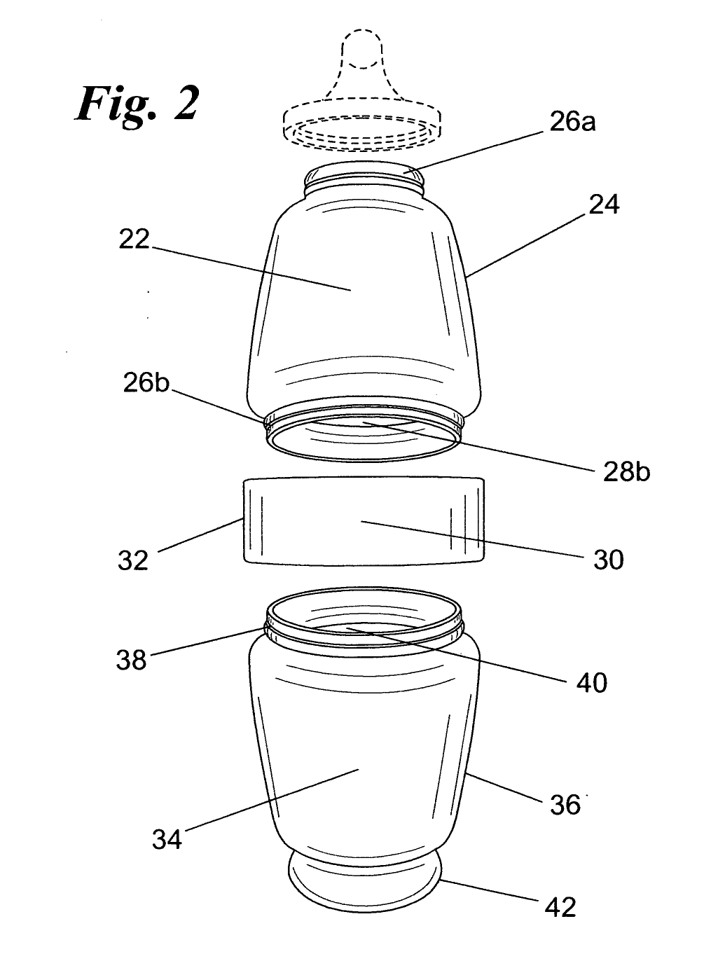

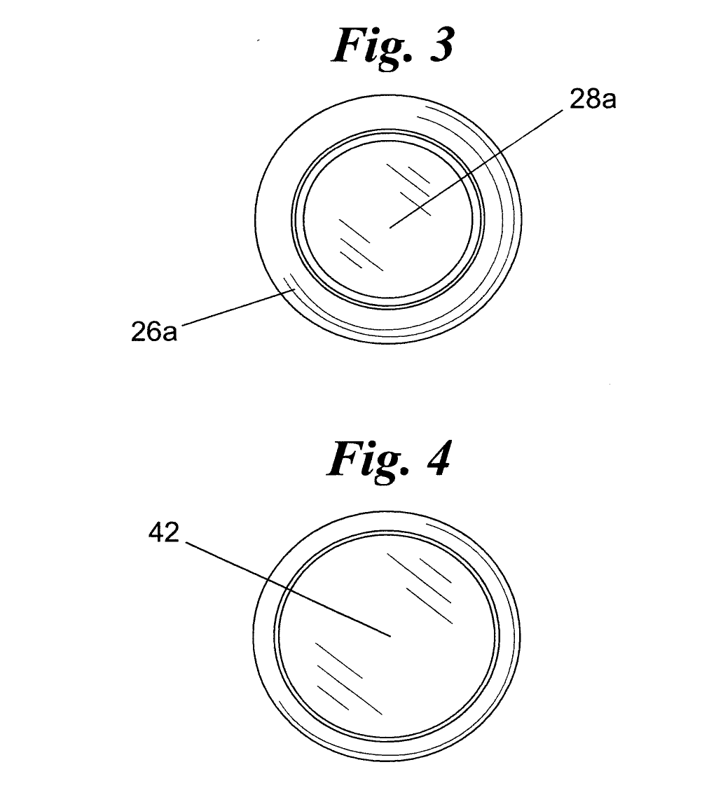

Referring now to the drawings and particularly to FIG. 1, the invention is a baby feeding bottle 20 specially made for cleaning without the use of a brush. The present invention 20 accommodates cleaning with a human hand and eliminates the need for cleaning with a brush. The diameter of the apertures 28a (as shown in FIG. 3), 28b (as shown in FIG. 2) of upper body 22, the diameter of the aperture (unshown) of coupler 30, and the diameter of the aperture 40 (as shown in FIG. 2) of lower body 34 allow for ease of cleaning the assembled baby bottle 20 with the human hand and eliminates the need to use a brush to clean the bottle.

Referring to FIG. 2, this exploded view of baby bottle 20 shows the upper body 22, coupler 30, and lower body 34 in an unassembled state. As seen in the figure, the upper body 22 is comprised of an exterior surface 24, an interior surface (not shown) at least two apertures 28a (as shown in FIG. 3), 28b, and threaded necks 26a, 26b around the apertures 28a (as shown in FIG. 3), 28b. The apertures 28a (as shown in FIG. 3), 28b are of sufficient size to accommodate a human hand for cleaning the bottle. The preferred diameter of apertures 28a (as shown in FIG. 3), 28b is 2.36 inches and the preferred thickness of upper body 22 is 0.08 inches.

The coupler 30 is comprised of an exterior surface 32, a threaded interior surface (not shown), and an aperture (not shown). The aperture (not shown) of coupler 30 is of sufficient size to accommodate a human hand for cleaning the bottle. The preferred diameter of the aperture (unshown) of coupler 30 is 2.36 inches and the preferred thickness of the coupler is 0.08 inches.

The lower body 34 is comprised of an exterior surface 36, an interior surface (not shown), at least one aperture 40, and a threaded neck 38 around at least one aperture 40, and a base 42. The aperture 40 of lower body 34 is of sufficient size to accommodate a human hand for cleaning the bottle. Additionally, base 42 stabilizes the bottle such that the bottle remains stationary when placed on tables or other surfaces. The preferred diameter of aperture 40 is 2.36 inches and the preferred thickness of the lower body 34 is 0.08 inches.

FIG. 3 shows a top plan view of aperture 28a of upper body 22 (as shown in FIGS. 1-2) and the threaded, neck 26a of upper body 22 (as shown in FIGS. 1-2). The apertures 28a, 28b (as shown in FIG. 2) of upper body 22 (as shown in FIGS. 1-2) are of sufficient size to accommodate a human hand for cleaning the bottle.

FIG. 4 shows a bottom plan view of base 42 of lower body 34 (as shown in FIGS. 1-2). Base 42 stabilizes the lower body 34 (as shown in FIGS. 1-2) and stabilizes the assembled baby bottle 20 (as shown in FIG. 1) such that the bottle remains stationary when placed on surfaces.

The baby bottle 20 can be made from any impact resistant material such as plastic, stainless steel, tempered glass, rubber, metal, plastic, fabric or various other materials via blow molding, injection molding, or other manufacturing techniques. The material used to make baby bottle 20 and the method of manufacturing baby bottle 20 are not constrained to the types of materials or methods of manufacture described in this paragraph.

As shown in FIG. 1, assembled baby bottle 20 is comprised of an upper body 22, a lower body 34, and a coupler 30. The assembled baby bottle 20 can be cleaned in an assembled state. The baby bottle 20 can also be disassembled (as shown in FIG. 2) for easier cleaning and then re-assembled.

To disassemble and clean an assembled baby bottle 20, hold the assembled baby bottle 20 on a surface or with your hands. Then twist the upper body 22 in a counter clockwise direction until the upper body 22 has been unscrewed from the coupler 30. Next, twist the lower body 34 in a counter clockwise direction until the lower body 34 is unscrewed from the coupler 30. Finally, clean the individual upper body 22, lower 34 body, and coupler 30 using your hand, a cloth, and cleaning solution.

To assemble baby bottle 20, align the threaded neck 26b of upper body 22 with the coupler 30 and screw the upper body 22 into the coupler 30. Next, align the coupler 30 with the threaded neck 38 of the lower body 34 and screw the lower body 34 into the coupler 30. Finally, clean the assembled bottle using your hand, a cloth, and cleaning solution.

It is important to note that threaded necks 26a, 26b of upper body 22 and threaded neck 38 of lower body 34 will accept a wide variety of lids, caps, or attachments, including, but not limited to a nipple or sippy cup. This feature allows the baby bottle 20 to be converted from a larger size bottle to a smaller sized bottle. The convertible nature of the invention eliminates the need to buy (and dispose of) multiple bottles, cups, or storage containers during a child's growth and eliminates the need to dispose of such bottles or containers as the child grows.

It is anticipated that individual features of the baby bottle 20 (as shown in FIG. 1) can be changed, however, with substantially no effect on the overriding functionality and operative elements. The baby bottle 20 (as shown in FIG. 1) can be modified to adapt to different needs, with substantially no effect on the overriding functionality and operative elements. Examples of such modifications are the inclusion of at least one non-threaded neck on baby bottle 20 or the inclusion of non-threaded coupler. Additionally, variations of the invention may include slight changes in the diameter, shape, placement of the apertures 28a, 28b, 40. Similarly, the size, shape, and placement of the aperture (unshown) of the coupler (30) may be slightly changed. There are countless other examples of modifications that could be made to baby bottle 20 that have no substantial effect on the overriding functionality and operative elements. It is understood by those skilled in the art, that the measurements provided in this application are not to be construed as limits on the claims and variations will be in accordance to the particular application in which the invention is used.

It is to be understood that the foregoing description and specific embodiments are merely illustrative of the best mode of the invention and the principles thereof and that various modifications and additions may be made to the apparatus by those skilled in the art, without detracting from the spirit and scope of this invention, which is therefore understood to be limited only by the scope of the appended claims.

We claim:

1. An impact resistant baby bottle that accepts a variety of lids, caps, or attachments comprising:
a. an upper body having an exterior surface with at least two threaded necks, an interior surface, and at least two apertures of sufficient size to accommodate a human hand;
b. a lower body having an exterior surface with at least one threaded neck, an interior surface, at least one aperture of sufficient size to accommodate a human hand, and a base; and
c. a coupler having an exterior surface, a threaded interior surface, and an aperture of sufficient size to accommodate a human hand, said coupler connecting said upper body to said lower body.

2. The baby bottle of claim 1, wherein the diameter of the apertures of the upper body is equal to or greater than the diameter of the coupler.

3. The baby bottle of claim 1, wherein the diameter of the apertures of the upper body is less than the diameter of the coupler.

4. The baby bottle of claim 1, wherein the diameter of the aperture of the lower body is equal to or greater than the diameter of the aperture of the coupler.

5. The baby bottle of claim 1, wherein the diameter of the aperture of the lower body is less than the diameter of the aperture of the coupler.

6. The baby bottle of claim 1, wherein the diameter of the apertures of the upper body is equal to or greater than the diameter of the aperture of the lower body.

7. The baby bottle of claim 1, wherein the diameter of the apertures of the upper body is less than the diameter of the aperture of the lower body.

8. The baby bottle of claim 1, wherein the diameters of the apertures of the upper body, coupler, and lower body are less than 2.36 inches.

9. The baby bottle of claim 1, wherein the diameters of the apertures of the upper body, coupler, and lower body are at least 2.36 inches.

10. The baby bottle of claim 1, wherein the diameters of the apertures of the upper body, coupler, and lower body are greater than 2.36 inches.

11. The baby bottle of claim 1, wherein the upper body is made of impact resistant material such as plastic, stainless steel, tempered glass, rubber, metal, plastic, or fabric.

12. The baby bottle of claim 1, wherein the lower body is made of impact resistant material such as plastic, stainless steel, tempered glass, rubber, metal, plastic, or fabric.

13. The baby bottle of claim 1, wherein the coupler is made of impact resistant material such as plastic, stainless steel, tempered glass, rubber, metal, plastic, or fabric.

14. An impact resistant drinking apparatus that accepts a variety of lids, caps, or attachments comprising:
a. an upper body having an exterior surface with at least one threaded neck, an interior surface, and at least two apertures of sufficient size to accommodate a human hand;
b. a lower body having an exterior surface with at least one threaded neck, an interior surface, at least one aperture of sufficient size to accommodate a human hand, and a base; and
c. a coupler having an exterior surface, a threaded interior surface, and an aperture of sufficient size to accommodate a human hand, said coupler connecting said upper body to said lower body.

15. A method of making an impact resistant baby bottle that accepts a variety of lids, caps, or attachments comprising:
a. obtaining impact resistant material such as plastic, stainless steel, tempered glass, rubber, metal, plastic, or fabric;
b. using any conventional manufacturing process to create a mold of an upper body for said baby bottle, said mold having an exterior surface with at least two threaded necks, an interior surface, and at least two apertures of sufficient size to accommodate a human hand;
c. using any conventional manufacturing process to create a mold of a lower body for said baby bottle, said mold having an exterior surface with at least one threaded neck, an interior surface, at least one aperture of sufficient size to accommodate a human hand, and a base; and
d. using any conventional manufacturing process to create a mold of a coupler for said baby bottle, said mold having a coupler having an exterior surface, a threaded interior surface, and an aperture of sufficient size to accommodate a human hand;
e. aligning at least one said threaded neck of said upper body with the said coupler,
f. screwing said upper body into said coupler,
g. aligning said coupler with said threaded neck of said lower body, and
h. Screwing said lower body into said coupler.
